(19) United States
(12) Patent Application Publication
(10) Pub. No.: US 2014/0041251 A1
(43) Pub. Date: Feb. 13, 2014

(54) INTRODUCED IN SOLIDS DRYING EQUIPMENT THROUGH AXIAL FLOW PROCESS

(71) Applicant: Francisco Maria Ayala Barreto, Cascavel (BR)

(72) Inventor: Francisco Maria Ayala Barreto, Cascavel (BR)

(21) Appl. No.: 13/962,782

(22) Filed: Aug. 8, 2013

(30) Foreign Application Priority Data
Aug. 10, 2012 (BR) PI1020120200473

(51) Int. Cl. F26B 17/14

(52) U.S. Cl. CPC F26B 17/14
USPC 34/498; 34/167

(57) ABSTRACT

Solids drying equipment via an axial flow process can include a plenum, a product to dry distributor feeder, drying air distribution pipe, one or more upper diffusion modules(s), one or more drying chamber(s), lower air diffusion module, with four to sixteen discharge bases with a hollow pyramidal format, discharge hopper, with a sluice, with a drying air feeding pipe and with a vertical output air tube provided with air output extensions. Such equipment may obtain better productivity and may allow for uniform insufflation of a large volume of air in a reduced space, for example, in addition to allowing seeds temperature to be maintained in safe levels due to the greater height of the drying layer, and allowing a progressive rest of seeds which, during motion by gravity, go towards the drying air at the bottom of the chamber.

### RELATED APPLICATIONS

This nonprovisional patent application claims priority to and the benefit of the filing date of BR PI 10 2012 020047 3, which was filed on 10 Aug. 2012 as an application for a patent of invention (PI) in Brazil by Applicant/Inventor Francisco Maria Ayala Barreto. The application BR PI 10 2012 020047 3 is incorporated by reference herein.

### TECHNICAL FIELD

Subject matter herein pertains generally to solids drying.

### BACKGROUD

Patent document BR PI 1103152-2, to Ayala Barreto, which is incorporated by reference herein, described (e.g., with reference to numerals in figures therein) use of a cover (1) with a hollow pyramidal format with four to sixteen sides and provided with a loading nozzle (1-A) and air output openings (1-B) forming a plenum (1-C) inside the drying chamber equipment comprised by the upper part of the drying chamber (3) and the cover (1); primary air pipe (2) surrounding the dryer on its upper part with a quantity of air openings equal to the quantity of sides of the dryer body, with a pipe (2-A) provided with closing dampers (2-A-1), connection nozzle (2-A-2) and secondary air pipes (2-A-3) in a quantity equal to twice the sides of the dryer body and connecting the air pipe (2) to the plenum (1-C); upper drying chamber (3) with a hollow polygonal shape with four to sixteen sides, provided with lateral sections (3-A) of rectangular or square formats and of a cleaning and inspection port (3-A-1); one or more diffusion modules (4) with a tray format with four to sixteen sides provided with an inner drying air distribution pipe (4-A) surrounding the dryer body comprised by compartments (4-A-1) with a trapezoidal format in a quantity equal to the number of sides of the body communicating among themselves through lateral openings (4-A-1-A) and communicating with a drying air input nozzle (4-A-1-B), of drying cells (4-B) on a pierced plate comprised by compartments of trunk-pyramidal format, with lower opening (4-B-1) on each, with a trapezoidal format, communicating with a product output pipe from the drying module (4-B-2) with a prismatic rectangular format and connected to a lower plate (4-B-3) of the tray, communicating with the product discharge pipes (4-B-4) with a rectangular prismatic format on the lower tip and provided with a central pipe for return of the saturated drying air (4-C) with a polygonal trunk-prismatic format with an open upper part positioned at the center of the tray; with or without lower drying chamber(s) (5) with a hollow polygonal format with four to sixteen sides, provided with lateral sections (5-A) of rectangular or square format and with a cleaning and inspection port (5-A-1) and forming a plenum (5-B) on the upper part at the height of the product discharge pipes (4-B-4); lower air diffusion module (6) with a tray format with four to sixteen sides provided with an inner drying air pipe (6-A) surrounding the dryer comprised by compartments (6-A-1) with a trapezoidal prismatic format in a quantity equal to the number of sides of the body communicating one with another through lateral openings (6-A-1-A) and communicating with the drying air input nozzle (6-A-1-B), of second ring (6-B) comprised by compartments with a Trunk-pyramidal format with a lower orifice (6-B-1) on each, in a trapezoidal format, communicating with the product output pipe (6-B-2) with a rectangular prismatic format and connected to the lower plate (6-B-3) of the tray, communicating with the product discharge pipes (6-B-4) with a rectangular prismatic format chamfered on the lower tip and provided with a deflective pyramid (6-C) with a polygonal prismatic format with an upper part in pierced plate and positioned on the center of the tray with its base sealed with an access port removable for cleaning; discharge base (7) with a hollow pyramidal format with four to sixteen sides, provided with a discharging nozzle (7-A) with a circular format; by stands (8); by a sluice (9) fixed to the nozzle (7-A); and by an access ladder (10).

Said equipment performs the drying of agricultural products uniformly, without contamination, effective, with a low energy consumption, higher speed, and so as to maintain the physical, chemical, sanitary and nutritional qualities of agricultural products, performs drying in a non-aggressive manner (the product is exposed to the drying air at adequate temperature, moisture and time, allowing the migration by water desorption from inside the seed to its surface without putting in risk the physical integrity thereof), clean and without exposing to the weather, using equipment with optimized area and volume, with possibility of a high automation degree and injection of large volumes of drying air, with low operational cost and low energy consumption, with uniform air flow on the whole seed mass and maximum performance of drying air, and with a high production capacity. This new equipment design also presents an excellent operational flexibility, for it allows continuous or intermittent drying worth the mere opening or closure of air faucets, which is not possible with conventional dryers: They are either continuous or intermittent. Intermittent drying is that wherein seeds remain at rest, for some time, without receiving drying air to allow moisture migration from the center to the surface of the seed.

Even though it has been a great advance, the drying equipment revealed in said patent document BR PI 1103152-2 (e.g., described in part above), upon being exhaustively tested in practice, showed a need of constructive improvements that generated improvements hereof, which solved inconveniences, limitations and disadvantages of non-uniform drying air distribution and high moisture dispersion at the end of the process.

### SUMMARY

Subject matter herein pertains to, for example, improvements in solids drying equipment by axial flow process. Improvements may be through improvements in drying air distribution, saturated air return and constructive aspects, for better performance and seed moisture dispersion reduction at the end of drying and advantages of allowing uniform insufflation of a large air volume in a reduced space in addition to allowing seeds temperature to be maintained in safe levels due to the higher height of the drying layer, and allowing a progressive rest of seeds, which, during the motion due to gravity, go towards the drying air at the lower portion of the chamber, in the counter-current direction from the drying air.

Various improvements in solids drying equipment through axial flow process were developed to overcome the inconveniences and limitations of current devices, for they allow the insufflation of a large air volume in a reduced space, in addition to allowing seeds temperature to be maintained in safe levels due to the higher height of the drying layer. They also allow a progressive rest of seeds, which, during motion due to gravity, go towards the drying air at the lower part of the chamber.

### BRIEF DESCRIPTION OF THE DRAWINGS

For a better understanding hereof, the following figures are provided:

FIG. 1, depicting an upper perspective view of the solids dryer through axial flow, with five drying chambers hereof;

FIG. 1A, depicting the upper view of the solids dryer through axial flow with five drying chambers hereof;

FIG. 1B, depicting an lower perspective view of the solids dryer through axial flow, with five drying chambers hereof;

FIG. 1C, depicting an lateral perspective view of the solids dryer through axial flow, with five drying chambers hereof;

FIG. 2, depicting a lateral view in longitudinal cut of the solids dryer through axial flow, with five drying chambers hereof, without depicting the product to be dried and depicting the air flow;

FIG. 2A, depicting a lateral view in longitudinal cut of the solids dryer through axial flow, with five drying chambers hereof, depicting the product to be dried and depicting the air flow;

FIG. 3, depicting an upper perspective view of the feeder distributor of the product to dry of the solids dryer through axial flow hereof;

FIG. 4, depicting a blown-up perspective view of the drying air distribution pipe of the solids dryer through axial flow hereof;

FIG. 5, depicting an upper perspective view of the upper air diffuser, with straight segment of the central drying air distribution pipe, of the solids dryer through axial flow hereof;

FIG. 5A, depicting the lateral view of the upper air diffuser of the solids dryer through axial flow hereof;

FIG. 5B, depicting the lower view of the upper air diffuser of the solids dryer through axial flow hereof;

FIG. 5C, depicting the upper view of the upper air diffuser of the solids dryer through axial flow hereof;

FIG. 5D, depicting the upper perspective view of one module of the upper air diffuser without chamfer for the air output of the solids dryer through axial flow hereof;

FIG. 5E, depicting the upper perspective view of one module of the upper air diffuser with chamfer for the air output of the solids dryer through axial flow hereof;

FIG. 5F, depicting the upper perspective view of one element of fixation of the sectors of the upper air diffuser of the solids dryer through axial flow hereof;

FIG. 6, depicting an upper perspective view of the lower air diffuser, with straight segment of the central drying air distribution pipe, of the solids dryer through axial flow hereof;

FIG. 6A, depicting the lateral view of the upper air diffuser of the solids dryer through axial flow hereof;

FIG. 6B, depicting the lower view of the lower air diffuser of the solids dryer through axial flow hereof;

FIG. 6C, depicting the upper view of the lower air diffuser of the solids dryer through axial flow hereof;

FIG. 6D, depicting the lower perspective view of one module of the upper air diffuser without chamfer for the air output of the solids dryer through axial flow hereof;

FIG. 6E, depicting the lower perspective view of one module of the upper air diffuser with chamfer for the air output of the solids dryer through axial flow hereof;

FIG. 6F, depicting the upper perspective view of one element of fixation of the sectors of the lower air diffuser of the solids dryer through axial flow hereof;

FIG. 7, depicting the frontal perspective view of the set of intermediate hoppers with pipes and discharge hopper of the solids dryer through axial flow hereof;

FIG. 8, depicting the operational flowchart of the solids drying process through counter-current axial flow with four chambers and without exhausted air return hereof; and

FIG. 9, depicting the operational flowchart of the solids drying process through counter-current axial flow with four lower drying chambers and without exhausted air return and depicting the grains hereof.

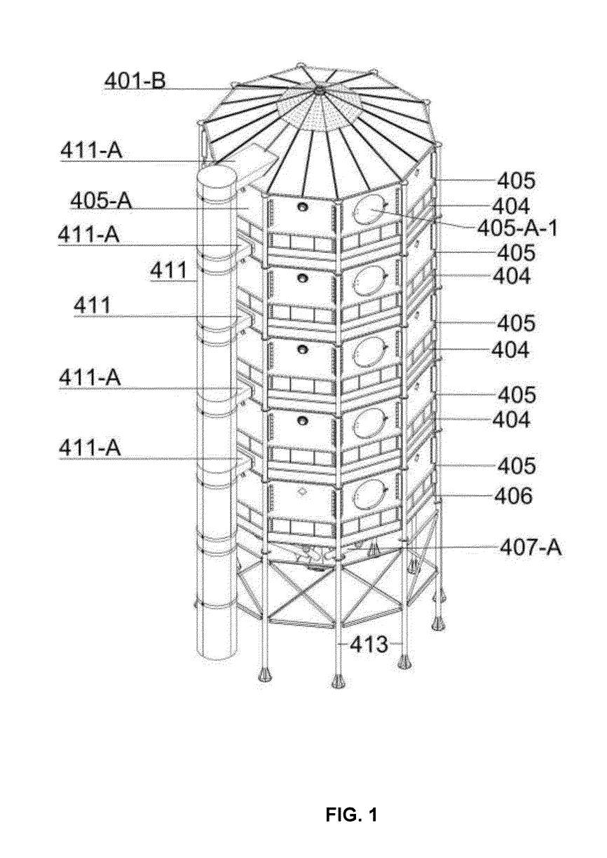

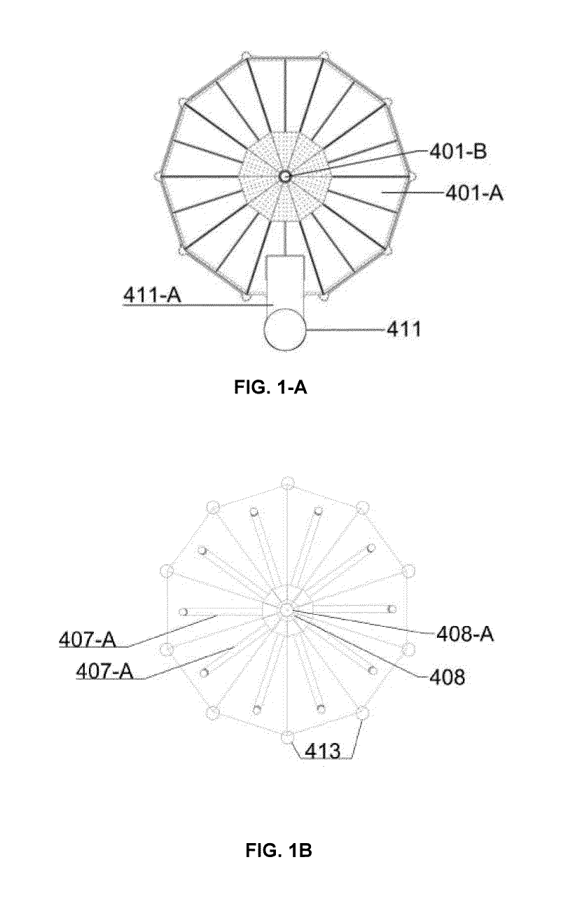

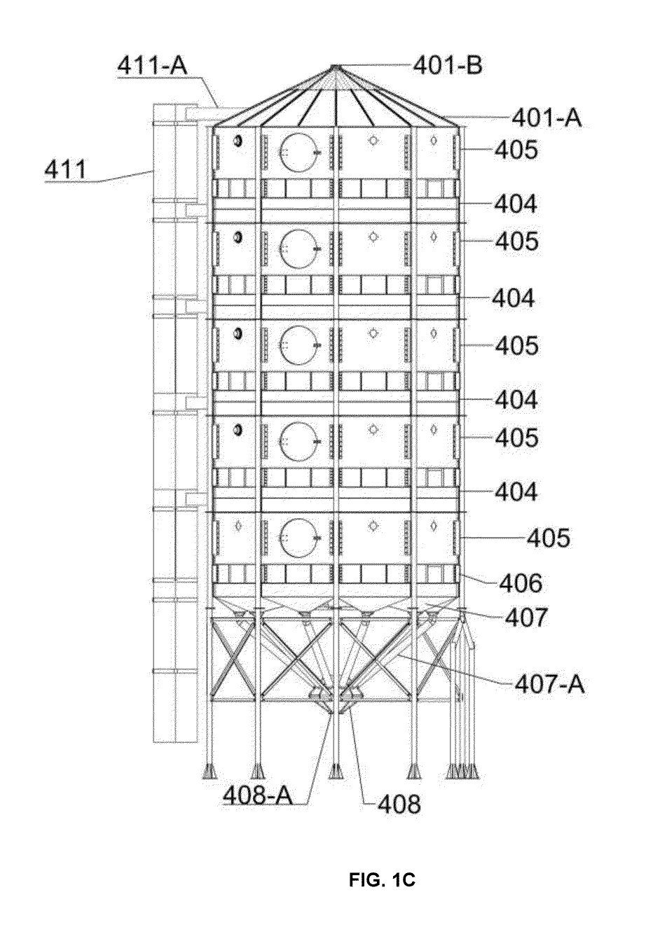

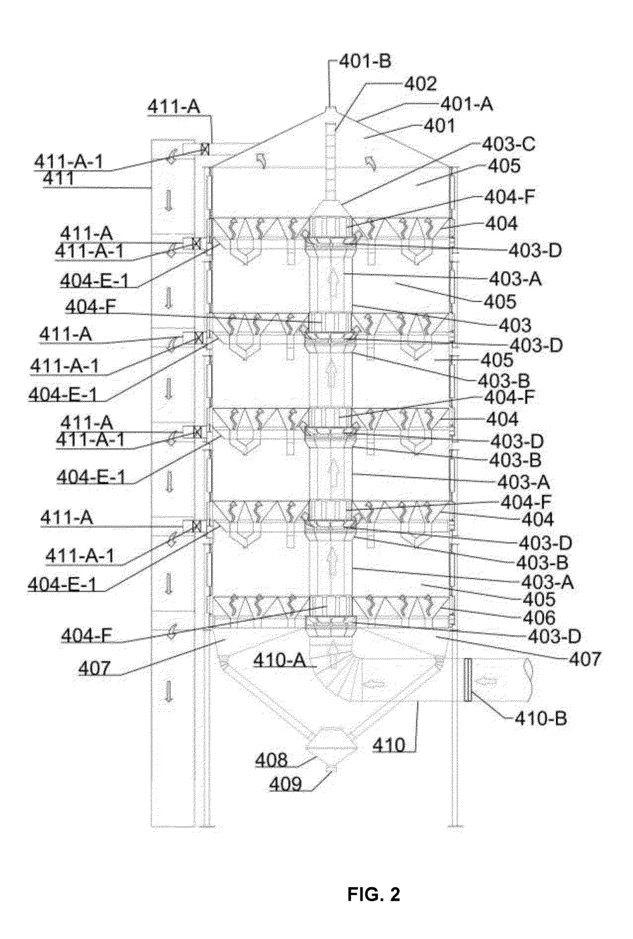

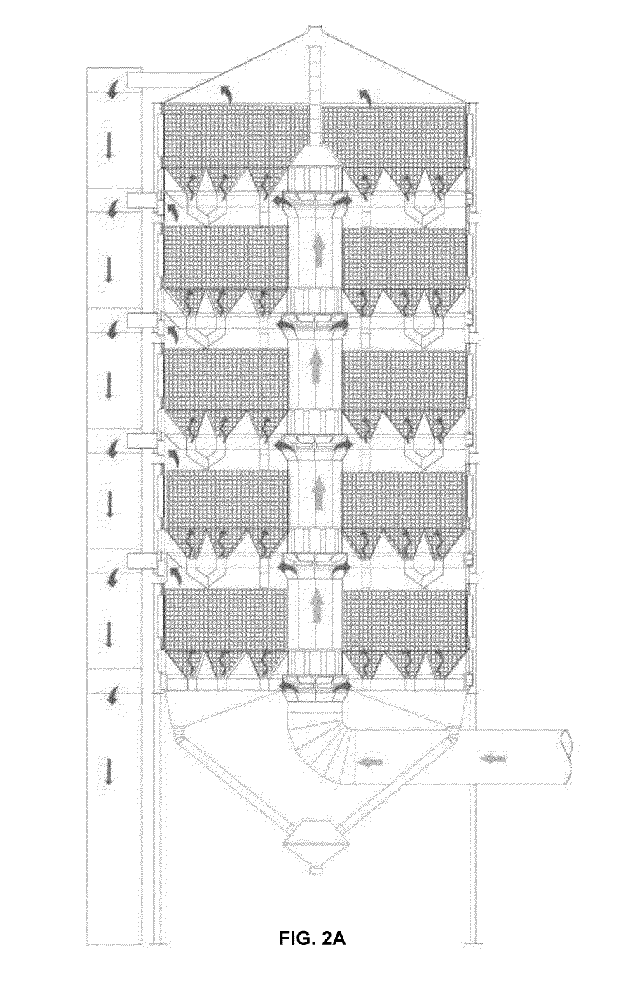

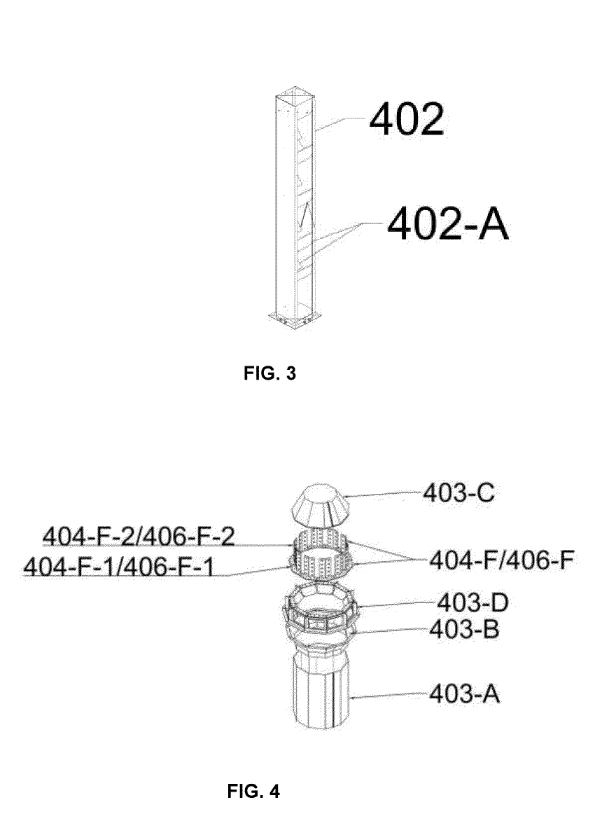

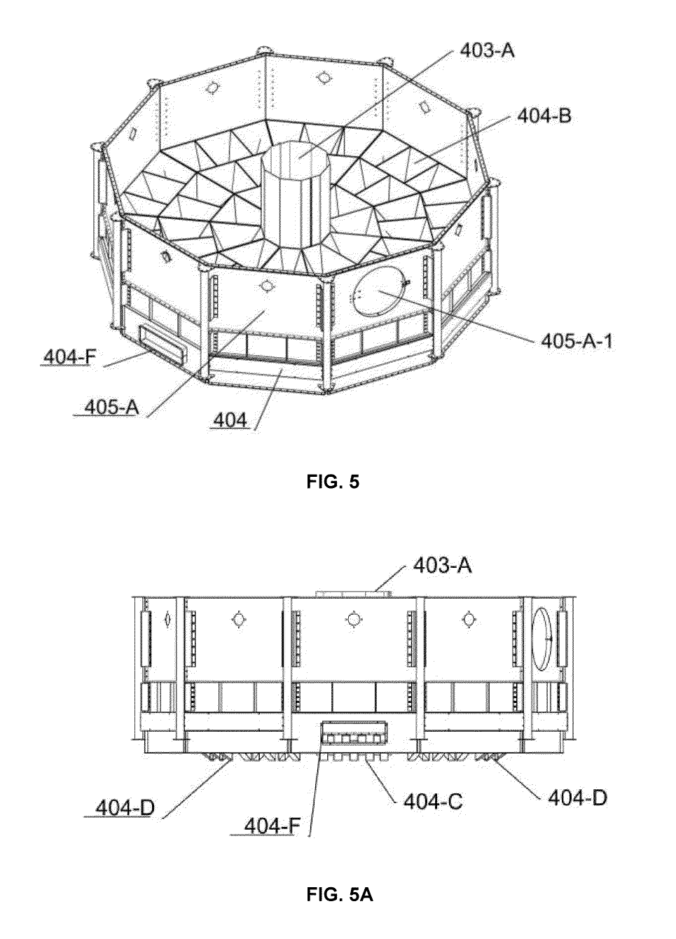

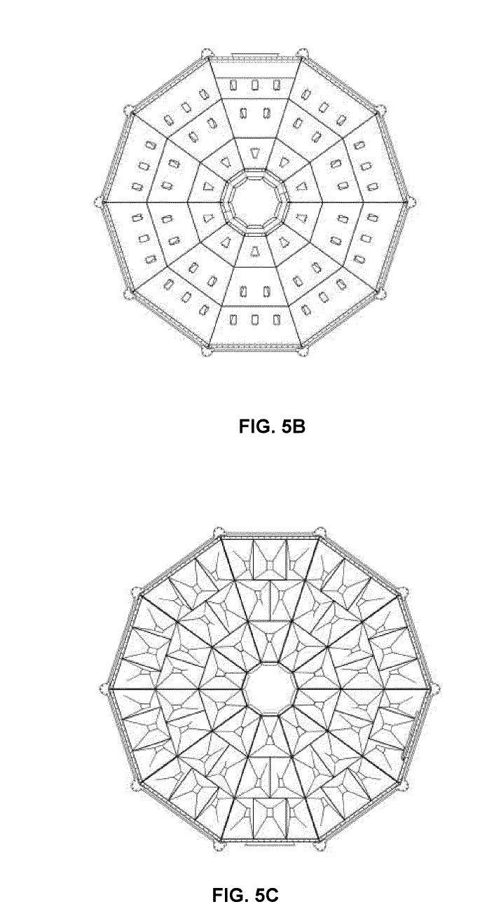

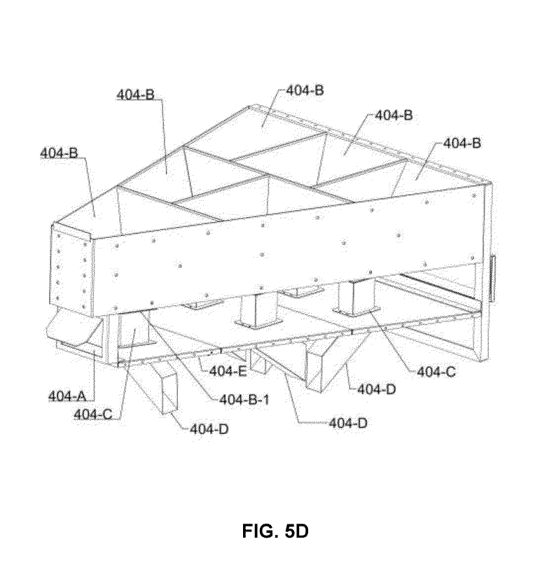

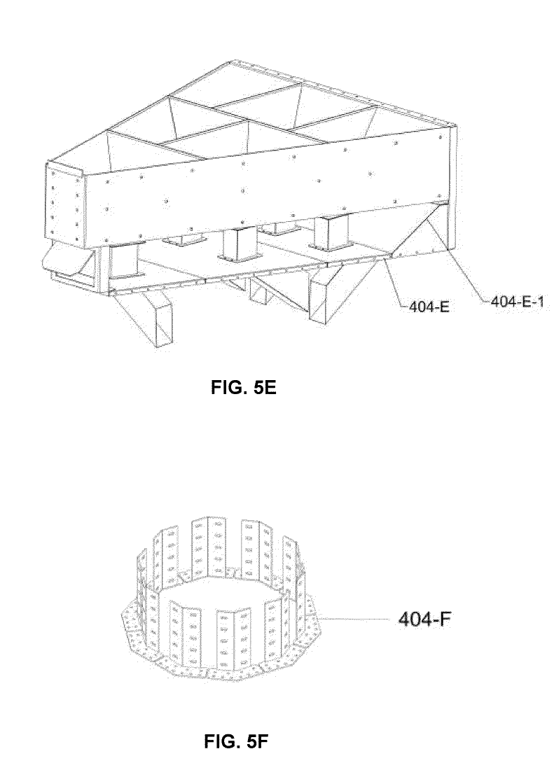

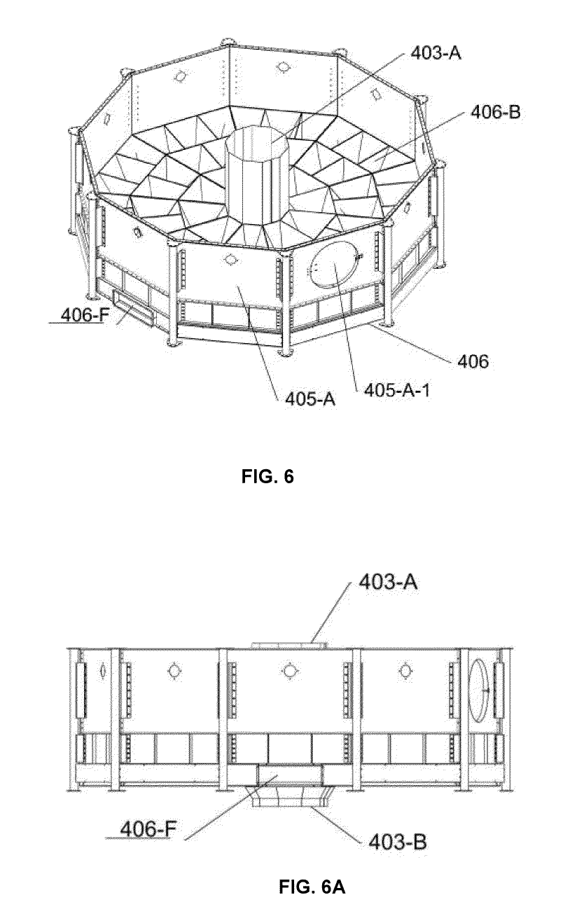

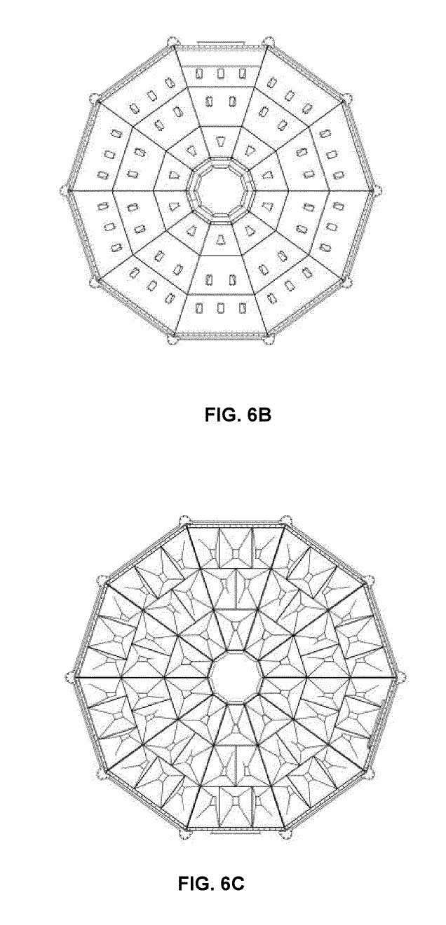

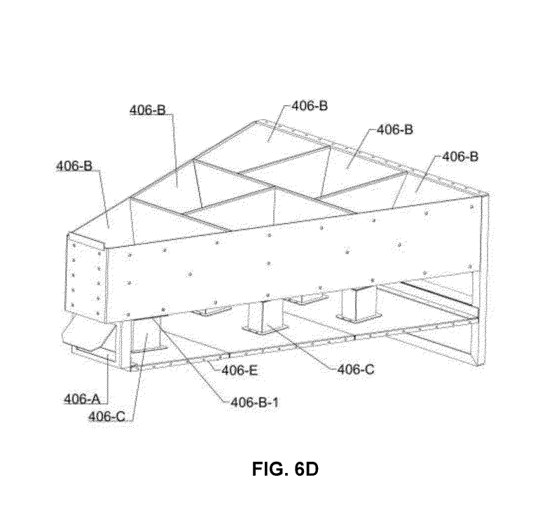

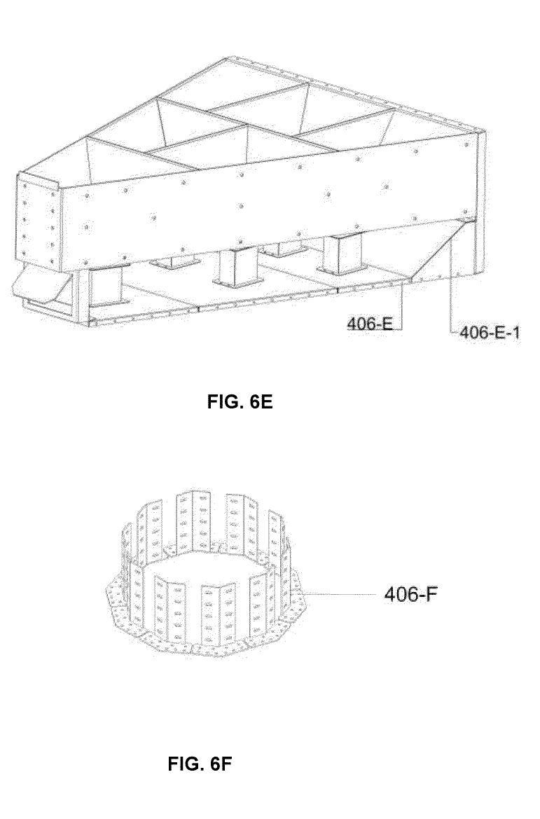

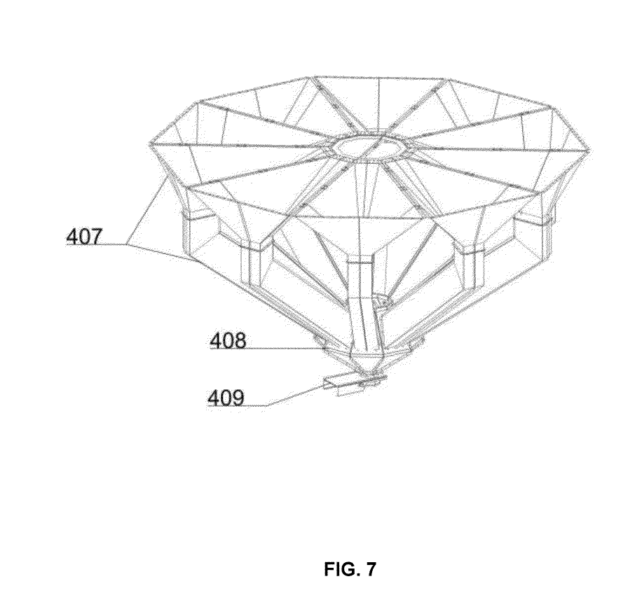

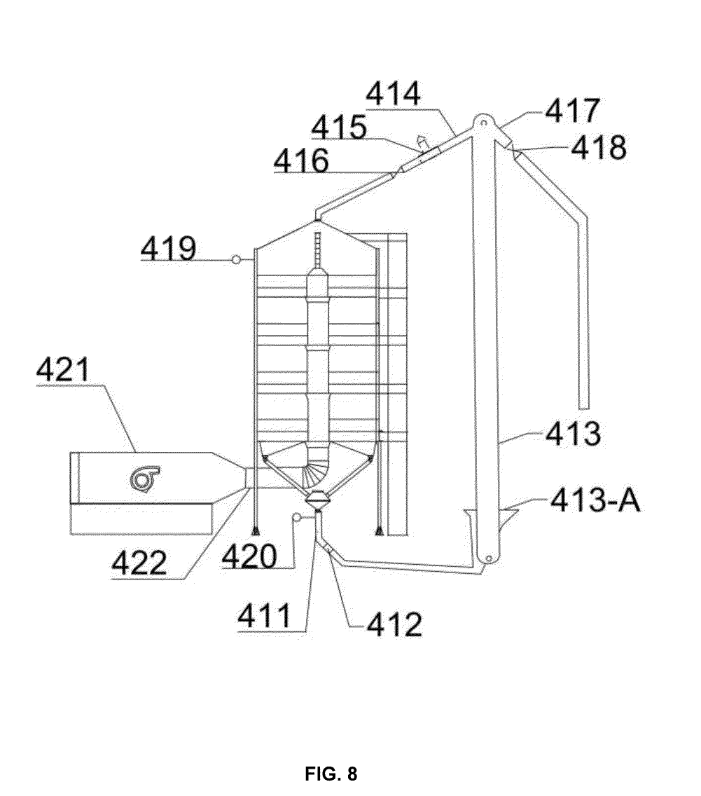

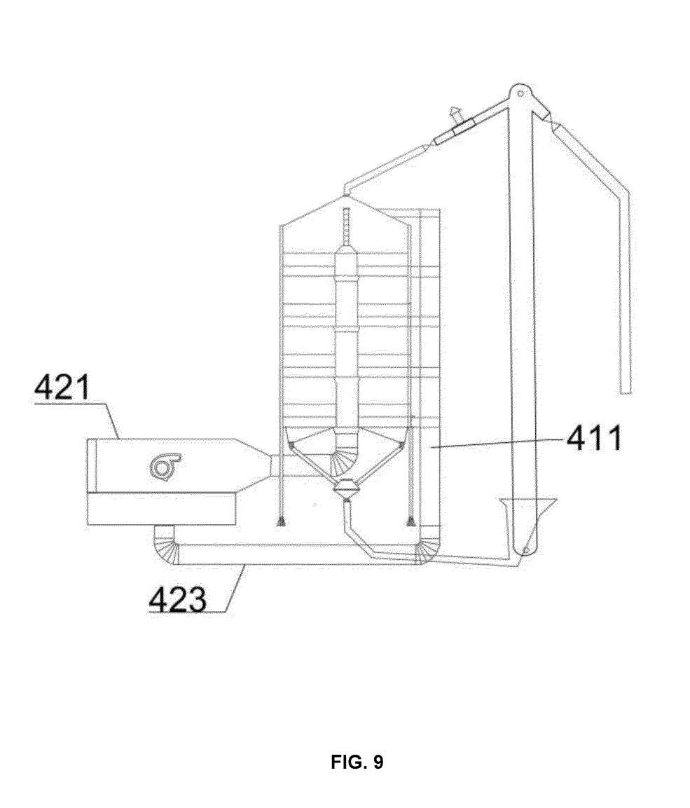

### DETAILED DESCRIPTION

The drying process hereof aims at drying solids with low or high moisture and temperature, particularly for sensitive products through the insufflation of heated air in low temperatures (for instance, application of ATUs for seeds) or high temperatures (use of gas-powered furnace or burner, or hot water or oil serpentines, or vapor serpentines for grains).

The drying system shall be by counter-current flow, wherein air is insufflated against the direction of solids to dry, and may also use as energy source fossil combustibles or firewood.

Air used in drying may be reused and recirculated or not, due to the psychrometric properties of ambient air and recirculation air and of the drying air supply (ATU, for instance). The mix of 0 to 100% between ambient air and return air is possible.

After ostensive research and development in prototypes, it was concluded that the best alternative in terms of efficiency is equipment comprised by one plenum for return of saturated air (401) from the drying process, comprised by the inner space created between the cover (401-A) and the upper part of the upper-most drying chamber (405), with a hollow pyramidal format with four to sixteen sides and provided with a loading nozzle (401-B); one distributor feeder of the damp ladder type of product to dry (402) with a prismatic format with steps (402-A) internally mismatched and positioned on the lid (403-C) and aligned to the loading nozzle (401-B); central pipe of drying air distribution (403) with a polygonal prismatic format with the same number of sides as the dryer, with: straight segments (403-A) positioned on the center of the equipment above the diffusion modules (404) and (406) and going through the drying chambers (405), with scaled segments (403-B) positioned at the center of the equipment below the diffusion modules (404) and (406), sealing ring (403-D) positioned in front of the drying air input nozzles (404-A) and (406-A) of the diffusion modules (404) and (406) and lid (403-C) with a conical format and positioned on the upper face of the last upper diffusion module (404), connected to the curve (410-A) of the drying air feeding tube (410) and communicating with the drying air input nozzles (404-A) and (406-A) of diffusion modules (404) and (406); one or more upper diffusion module(s) (404) with a tray format with four to sixteen sectors, each one provided with a drying air input nozzle (404-A) connected to the scaled segment (403-B) of the drying air distribution pipe (403), drying cells (404-B) on a pierced plate comprised by compartments of trunk-pyramidal format with a lower opening (404-B-1) at each one, communicating with the product output pipe (404-C) with a straight prismatic format on the central part and with the product output pipe (404-D) with a prismatic format and tilted at the other parts, straight lower plates (404-E) of horizontal closure comprising one plenum of distribution of drying air on the lower part of the drying cells (404-B) and with one of the chamfered sectors (404-E-1) comprising one plenum of saturated air return aligned with the air output extension (411-A), and fixation element of the sectors of the diffusion module (404-F) with a ring format with lower flange (404-F-1) and four to sixteen vertical fixation plates (404-F-2) with oblong holes; one or more drying chamber(s) (405) of hollow polygonal format with four to sixteen sides, provided with lateral sections (405-A) of rectangular or square format and with a cleaning and inspection port (405-A-1); lower air diffusion module (406) with a tray format with four to sixteen sectors, each one provided with drying air input nozzle (406-A) connected to the scaled segment (403-B) of the drying air distribution pipe (403), of drying cells (406-B) on a pierced plate comprised by compartments of trunk-pyramidal format with a lower opening (406-B-1) on each one, communicating with the product output pipe (406-C) with a straight prismatic format and straight lower plates (406-E) of horizontal closure comprising one plenum of drying air distribution on the lower part of the drying cells (406-B) and with one of the sectors chamfered (406-E-1) forming one plenum of saturated air return aligned with the air output extension (411-A), and fixation element of the sectors of the diffusion module (406-F) with a ring format with lower flange (406-F-1) and four to sixteen vertical fixation plates (406-F-2) with oblong holes; with four to sixteen intermediate hoppers (407) with a hollow pyramidal format, with four to sixteen pipes (407-A) connected to the discharge hopper (408); discharge hopper (408) of double-cone format with an output nozzle (408-A); with a sluice (409) fixed to the nozzle (409-A); with a drying air feeding pipe (410) with a curve (410-A) and flange (410-B) and connected to the distribution pipe; with a vertical output air tube (411) provided with air output extensions (411-A) provided with manual or motorized air faucets (411-A-1) to allow operation with partial load or drying intermittence, communicating with the plenum (401) and with the plenums of saturated air return at the height of the diffusion modules (404) and (406), which communicate with the drying chambers (405); and with stands (413).

In order for drying to be efficient, uniform and to not harm the product through too fast dehydration, it may be necessary to allow waiting at the drying process, in order for moisture of stronger connection of seeds or grains to migrate to the surface and be removed by drying air. For such, there are four options:
a) Letting the product in rest inside the drier, for a convenient time, some minutes or hours, shutting down the drying air supply; or
b) Installing one or more lung silos, with the same static capacity of the dryer and interconnected through elements for motion of the product between them, to allow the desired rest; or
c) Closing the air faucets (411-A) in an intercalated manner to prevent air injection in the chambers where one intends to put the product in drying rest, however, preserving its descending motion. For instance: We may close two intercalated faucets (411-A) to cease injecting drying air and thus leave the product at rest.

In the drying equipment, we also use a moisture determiner (412), conventional vertical transporter (413), provided with a conventional hopper (413-A); product to dry input block valve (414); dust capturer (415); input blocking valve of product to dry (416); dry product output pipe (417); product to dry output block valve (418); level indicator sensor (419); dry product temperature indicator sensor (420); drying air supply equipment (421), preferably the equipment of patent request PI0703605-1; dry drying air pipe (422); and optionally, re-heating air return pipe (423).

The drying process hereof occurs through a counter-current process, and the drying air supplied by the drying air conditioning equipment (421) which may be a gas-powered furnace or burner or hot water or oil serpentines or vapor serpentines.

The drying process carried out by the drying equipment hereof occurs in the steps below:

A. Dryer Loading

A.1) Products to dry are automatically or manually fed to the hopper (413-A) and fall due to gravity directly on the vertical transporter (413);

A.2) The sluice (409) and the flow valve (418) of the dry product output piping (417) are closed and the flow valve (416) of the product to dry input piping (414) is opened, the vertical transporter (413) is triggered so as the product is forwarded to inside the equipment until it reaches the established level indicated by the level indicator sensor (419), provided that the discharge hopper (408) and the drying chamber (405) are filled; and

A.3) Upon the conclusion of the supply step, the vertical transporter (413) is kept on and supply is interrupted at the hopper (413-A) and the sluice (409) is opened.

B. Drying

B.1) The drying air supply or the drying air conditioning equipment (421) supplying air, directly to the drying equipment to the desired drying air temperature and moisture are triggered;

B.2) Products located in the drying chamber(s) are dried intermittently, however, with a continuous motion of the product and air during the batch process, and may also operate with drying in a continuous regime, without intermittence. For this step, dry air is led through the dry air pipe (422) to the drying equipment, goes in through the flange (410-B), goes through the drying air feeding pipe (410), goes through the scaled segment (403-B) of the drying air distribution pipe (403) and goes in through the drying air input nozzle (406-A) in the lower air diffusion module (406) and through the drying air input nozzle(s) (404-A) in the upper air diffusion module(s) (404) supplying drying air to each cell and initially does through the material to dry through pierced plates on the tilted part of the drying cells (404-B) and (406-B) and, then, goes axially through the layer of material to dry contained in the drying chamber (405) arriving as humid air in the plenums formed by the chamfer (406-E-1) and through the chamfer(s) (404-E-1) at the height of the lower air diffusion module (406) and of the upper air diffusion module(s) (404) and in the plenum (401) connected to extensions (411-A), which connect to the output air pipe (411);

B.3) The product is motioned in an uninterrupted manner or not, through the sluice (409) either through cyclic or open/close action, and are taken periodically at the moisture collection point or are followed-up through the moisture determiner (412); and

B.4) After satisfactory conclusion of the drying step through batches or continuously, reaching the desired moisture, the equipment is turned off (421):

C. Discharge: Products with the desired moisture are removed, first opening the sluice (409) and the flow valve (418) of the dry product output piping (417), and closing the flow valve (416) of the product to dry input piping (414), so as the vertical transporter (413) discharges all product with the desired moisture out of the equipment through the dry product output piping (417).

Optionally, the air outlet will be able to be recirculated, connecting air tube exit (411) in the return air duct to reheat (423) feeding back or supplied-air drying (421), which feeds back through the dryer duct dry air (423) that connects the flange (410-B).

What is claimed is:

1. Equipment for solids drying comprising:
one plenum for return of saturated air (401) from a drying process, comprised by an inner space created between a cover (401-A) and an upper part of an upper-most drying chamber (405), with a hollow pyramidal format with four to sixteen sides and provided with a loading nozzle (401-B);
one distributor feeder of a damp ladder type of product to dry (402) with a prismatic format with steps (402-A) internally mismatched and positioned on a lid (403-C) and aligned to the loading nozzle (401-B);
a central pipe of drying air distribution (403) with a polygonal prismatic format with the same number of sides as a dryer, with: straight segments (403-A) positioned at a center of the equipment, above diffusion modules (404) and (406) and going through the drying chambers (405), with a scaled segment (403-B) positioned at the center of the equipment below the diffusion modules (404) and (406), a sealing ring (403-D) positioned in front of drying air input nozzles (404-A) and (406-A) of the diffusion modules (404) and (406) and a lid (403-C) with a conical format and positioned on an upper face of a last upper diffusion module of the diffusion modules (404) and (406), connected to the curve (410-A) of a drying air feeding tube (410) and communicating with the drying air input nozzles (404-A) and (406-A) of the diffusion modules (404) and (406);
one or more upper diffusion modules of the diffusion modules (404) and (406) with a tray format with four to sixteen sectors, each one provided with the drying air input nozzle (404-A) connected to the scaled segment (403-B) of the drying air distribution pipe (403), drying cells (404-B) on a pierced plate comprised by compartments of trunk-pyramidal format with a lower opening (404-B-1) on each one, communicating with a product output pipe (404-C) with a straight prismatic format on a central part and with a product output pipe (404-D) with a prismatic format and tilted on the other parts, straight lower plates (404-E) of horizontal closure, forming one drying air distribution plenum on a lower part of the drying cells (404-B) and with one of the sectors chamfered (404-E-1) forming one plenum of saturated air return aligned with an air output extension (411-A), and fixation element of the sectors of a diffusion module (404-F) with a ring format with lower flange (404-F-1) and four to sixteen vertical fixation plates (404-F-2) with oblong holes;
one or more drying chamber(s) (405) of hollow polygonal format with four to sixteen sides, provided with lateral sections (405-A) of rectangular or square format and with a cleaning and inspection port (405-A-1);
one or more lower air diffusion modules of the diffusion modules (404) and (406) with a tray format with four to sixteen sectors, each one provided with drying air input nozzle (406-A) connected to the scaled segment (403-B) of the drying air distribution pipe (403), with drying cells (406-B) in pierced plate formed b compartments of trunk-pyramidal format with a lower opening (406-B-1) on each one, communicating with the product output pipe (406-C) with a straight prismatic format and straight lower plate (406-E) of horizontal closure forming one drying air distribution plenum on the lower part of the drying cells (406-B) and with one of the sectors chamfered (406-E-1) forming one plenum of saturated air return aligned with the air output extension (411-A), and fixation element of the sectors of the diffusion module (406-F) with a ring format with lower flange (406-F-1) and four to sixteen vertical fixation plates (406-F-2) with oblong holes;
with four to sixteen intermediate hoppers (407) with a hollow pyramidal format, with four to sixteen pipes (407-A) connected to discharge hopper (408);
discharge hopper (408) of double-cone format with an output nozzle (408-A);
with a sluice (409) fixed to the nozzle (409-A);
with a drying air feeding pipe (410) with a curve (410-A) and flange (410-B) and connected to the distribution pipe;
with a vertical output air tube (411) provided with air output extensions (411-A) provided with manual or motorized air faucets (411-A-1) to allow operation with partial load or drying intermittence, communicating with the plenum (401) and with the plenums of saturated air return at the height of the diffusion modules (404) and (406), which communicate with the drying chambers (405); and
with stands (413).

2. A method for solids drying using drying equipment, the method comprising:
A. dryer loading
A.1) products to dry are automatically or manually fed to a hopper (413-A) and fall due to gravity directly on a vertical transporter (413);
A.2) a sluice (409) and a flow valve (418) of the a product output piping (417) are closed and a flow valve (416) of the product to dry input piping (414) is opened, the vertical transporter (413) is triggered so as the product is forwarded to inside the drying equipment until it reaches the established level indicated by a level indicator sensor (419), provided that a discharge hopper (408) and a drying chamber (405) are filled; and
A.3) upon the conclusion of a supply step, the vertical transporter (413) is kept on and supply is interrupted at the hopper (413-A) and the sluice (409) is opened;
B. drying
B.1) drying air supply or drying air conditioning equipment (421) supplying air, directly to drying equipment to the desired drying air temperature and moisture are triggered;
B.2) product located in the drying chamber(s) are dried intermittently, however, with a continuous motion of the product and of air during the batch processing, and may also operate with drying in continuous regime without intermittence; for this step, dry air is led through a dry air pipe (422) to the drying equipment, goes in through a flange (410-B), goes through a drying air feeding pipe (410), goes through a scaled segment (403-B) of a drying air distribution pipe (403) and goes in through a drying air input nozzle (406-A) in a lower air diffusion module (406) and through a drying air input nozzle(s) (404-A) in an upper air diffusion module(s) (404) supplying drying air to each cell and goes initially through the material to dry through pierced plates on the tilted part of drying cells (404-B) and (406-B) and then, goes axially through the later of material to dry contained in a drying chamber (405) arriving as humid air at the plenums formed by a chamfer (406-E-1) and through a chamfer(s) (404-E-1) at the height of the lower air diffusion module (406) and of the upper air diffusion module(s) (404) and in a plenum (401) connected to air output extensions (411-A), which connect to an output air tube (411);
B.3) the product is motioned in an uninterrupted manner or not, through the sluice (409) either through cyclic or open/close action, and are taken periodically at the moisture collection point or are followed-up through a moisture determiner (412); and
B.4) after satisfactory conclusion of the drying step through batches or continuously, reaching the desired moisture, the drying air supply or drying air conditioning equipment (421) is turned off; and
C. discharging
products with the desired moisture are removed, first opening the sluice (409) and the flow valve (418) of the dry product output piping (417), and closing the flow valve (416) of the product to the dry input piping (414), so as the vertical transporter (413) discharges all product with the desired moisture out of the equipment through the dry product output piping (417).

3. The method of claim 2 characterized by, optionally, the output air being able to be recirculated, interconnecting the output air tube (411) in the reheating air return pipe (423) feeding back the drying air supply or drying air conditioning equipment (421), which feeds back the dryer through the dry air tube (423) connected to the flange (410-B).

4. A method for solids drying comprising:
carrying out an efficient, uniform drying process, not harming product through very fast dehydration, and there may be the need of allowing waiting in drying, so as moisture with stronger connection of seeds or grains migrates to their surface, being able to be removed by the drying air, characterized by the following options:
a) letting the product in rest inside a drier, for a convenient time, some minutes or hours, shutting down drying air supply; or
b) installing one or more lung silos, with the same static capacity of the dryer and interconnected through elements for motion of the product between them, to allow the desired rest; or;
c) closing air faucets in an intercalated manner to prevent air injection in chambers where one intends to put the product in drying rest, however, preserving its descending motion.
